(19) United States
(12) Patent Application Publication
(10) Pub. No.: US 2026/0056612 A1
(43) Pub. Date: Feb. 26, 2026

(54) INFORMATION PROCESSING DEVICE, INFORMATION PROCESSING METHOD, AND COMPUTER PROGRAM PRODUCT

(71) Applicant: JVCKENWOOD Corporation, Yokohama-shi (JP)

(72) Inventor: Takamitsu Shimakura, Yokohama-shi (JP)

(21) Appl. No.: 19/318,435

(22) Filed: Sep. 4, 2025

Related U.S. Application Data
(63) Continuation of application No. PCT/JP2024/006209, filed on Feb. 21, 2024.

(30) Foreign Application Priority Data
Mar. 15, 2023 (JP) 2023-041238

(51) Int. Cl. G06F 3/01

(52) U.S. Cl. CPC G06F 3/015

(57) ABSTRACT

An information processing device includes a brain information obtaining unit that obtains brain information of a subject; a filtering unit that selects only specific information from the brain information obtained by the brain information obtaining unit; and an output unit that outputs the specific information, which is selected by the filtering unit, to a subject.

### CROSS-REFERENCE TO RELATED APPLICATIONS

This application is a Continuation of PCT International Application No. PCT/JP2024/006209 filed on Feb. 21, 2024 which claims the benefit of priority from Japanese Patent Application No. 2023-041238, filed on Mar. 15, 2023, the entire contents of both of which are incorporated herein by reference.

### BACKGROUND OF THE INVENTION

### 1. Field of the Invention

The application concerned is related to an information processing device, an information processing method, and a computer program product.

### 2. Description of the Related Art

In recent years, there has been advancements in the technology for measuring brain activation information; and the technology of a brain-machine interface, which serves as an interface between the brain and the outside, is becoming feasible. In Japanese Patent Application Laid-open No. 2008-279190 mentioned below, the explanation is given about performing brain activation, which is suitable for the training for brain activation, by storing the correspondence relationship of a plurality of sensory stimulation units with the types of stimulations applicable to the five senses; simultaneously applying, to a player, stimulations meant for a plurality of correlated senses; controlling the sensory stimulation units and providing the player with two or more types of stimulations; enabling selection of at least one type of stimulation; and making the player select the association among the senses.

However, in Japanese Patent Application Laid-open No. 2008-279190 mentioned above, even if it is possible to use one's own brain activity, there is no mention about sharing or controlling the brain activity of other persons.

### SUMMARY OF THE INVENTION

It is an object of the present invention to at least partially solve the problems in the conventional technology.

The above and other objects, features, advantages and technical and industrial significance of this invention will be better understood by reading the following detailed description of presently preferred embodiments of the invention, when considered in connection with the accompanying drawings.

An information processing device according to the present disclosure comprising: a brain information obtaining unit that obtains brain information of a subject; a filtering unit that selects only specific information from the brain information obtained by the brain information obtaining unit; and an output unit that outputs the specific information, which is selected by the filtering unit, to a subject.

An information processing method according to the present disclosure comprising: obtaining brain information of a subject; selecting only specific information from the obtained brain information; and outputting the selected specific information to a subject.

A computer program product according to the present disclosure having a computer readable medium including a computer program, wherein the computer program, when executed by a computer, causes the computer to execute: obtaining brain information of a subject;
selecting only specific information from the obtained brain information; and outputting the selected specific information to a subject.

### BRIEF DESCRIPTION OF THE DRAWINGS

FIG. 1 is a block configuration diagram illustrating an information processing device according to an embodiment;

FIG. 2 is a block configuration diagram illustrating a filtering unit; and

FIG. 3 is a flowchart for explaining an information processing method according to the present embodiment.

### DETAILED DESCRIPTION OF THE PREFERRED EMBODIMENTS

An exemplary embodiment of an information processing device, an information processing method, and a computer program product according to the application concerned is described below in detail with reference to the accompanying drawings. However, the application concerned is not limited by the embodiment described below.

### First Embodiment

### Information Processing Device

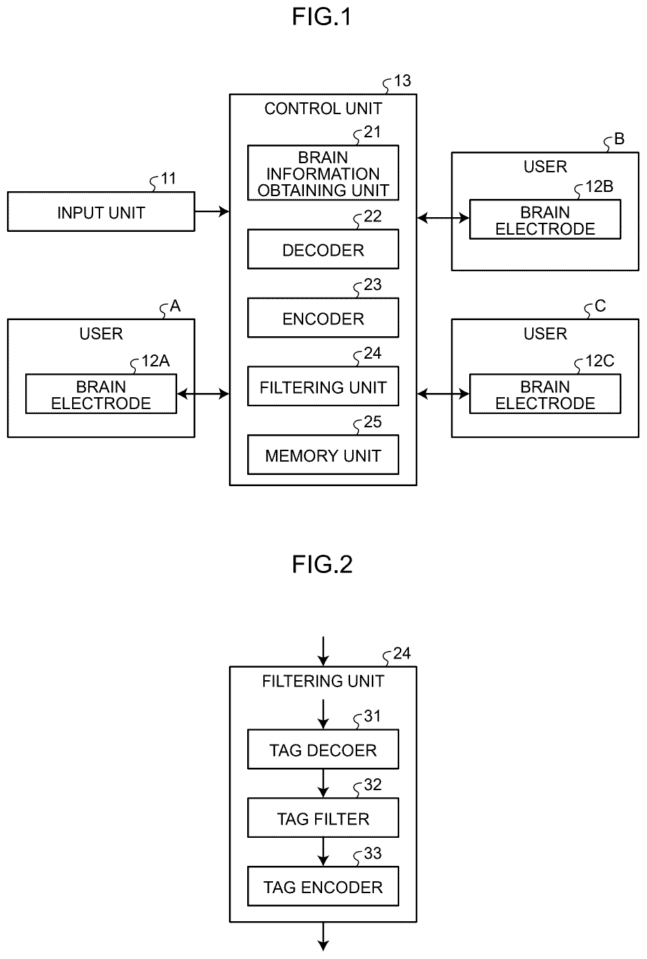

FIG. 1 is a block configuration diagram illustrating an information processing device according to a first embodiment.

As illustrated in FIG. 1, an information processing device 10 enables sharing of information among a plurality of users (subjects). The information processing device 10 outputs only specific information, which contains brain information obtained from a first-type user, to second-type users and thus enables sharing of information. In the following explanation, it is assumed that there is one first-type user and two second-type users. However, it is also possible to either have only one second-type user or have three or more second-type users.

The information processing device 10 includes an input unit 11, brain electrodes (measuring units, output units) 12A, 12B, and 12C, and a control unit 13.

The input unit 11 is connected to the control unit 13. The input unit 11 is configured to be operable by a user and is capable of inputting various signals to the control unit 13. For example, to the control unit 13, the input unit 11 inputs a start signal for starting operation control meant for performing an operation to enable sharing of brain information, and inputs an end signal for ending the operation control meant for performing the operation to enable sharing of brain information. The input unit 11 can be implemented using, for example, a touch-sensitive panel, a button, a switch, or a keyboard.

The brain electrodes 12A, 12B, and 12C function as measuring units and output units. The brain electrodes 12A, 12B, and 12C are worn by users A, B, and C, respectively. The brain electrode 12A is attached to the head region of the user A. The brain electrode 12B is attached to the head region of the user B. The brain electrode 12C is attached to the head region of the user C.

The brain electrodes 12A, 12B, and 12C function as measuring units that obtain the brain waves representing the brain information of the corresponding users. Moreover, the brain electrodes 12A, 12B, and 12C function as output units that output the brain waves representing the brain information for the brains of the corresponding users. The brain electrodes 12A, 12B, and 12C are, for example, invasive electrodes. The brain electrodes 12A, 12B, and 12C detect the brain waves coming out from the weak electrical current flowing through the neural networks of the corresponding brains. When the users receive an external stimulation, the brain electrodes 12A, 12B, and 12C detect the electrical potential of the weak electrical current (i.e., detect electrical signals) based on the thoughts such as the mindset. Moreover, the brain electrodes 12A, 12B, and 12C stimulate the neural networks of the corresponding brains by treating the brain waves as the weak electrical current. Furthermore, the brain electrodes 12A, 12B, and 12C apply the electrical potential of a weak electrical current (i.e., apply electrical signals) to the corresponding users based on the events occurring on the outside.

The brain electrodes 12A, 12B, and 12C corresponding to the users A, B, and C, respectively, are connected to the control unit 13. The control unit 13 communicates the brain information with the brain electrodes 12A, 12B, and 12C. That is, the control unit 13 receives input of the electrical signals of the brain waves obtained by the brain electrodes 12A, 12B, and 12C. Moreover, the control unit 13 outputs the electrical signals of the brain waves to the brain electrodes 12A, 12B, and 12C.

Herein, it is assumed that the brain electrodes 12A, 12B, and 12C apply the brain waves as a weak electrical current to the neural networks of the corresponding brains and stimulate those brains. However, that is not the only possible case. Alternatively, the information processing device 10 can further include a TMS device (TMS stands for Transcranial Magnetic Stimulation), and a stimulation to the brains can be applied using the magnetism generated by the TMS device.

The control unit 13 is connected to the input unit 11 and to the brain electrodes 12A, 12B, and 12C corresponding to the users A, B, and C, respectively. The control unit 13 receives input of a variety of information from the input unit 11 and from the brain electrodes 12A, 12B, and 12C; as well as outputs a variety of information to the brain electrodes 12A, 12B, and 12C. The control unit 13 includes a brain information obtaining unit 21, a decoder 22, an encoder 23, a filtering unit 24, and a memory unit 25. The control unit 13 is configured using, for example, an arithmetic circuit such as a central processing unit (CPU).

The brain information obtaining unit 21 obtains the brain information of the users A, B, and C. The brain information obtaining unit 21 obtains the electrical signals of the brain waves of the users as detected by the brain electrodes 12A, 12B, and 12C.

The brain information obtaining unit 21 is connected to the decoder 22. The decoder 22 converts the electrical signals of the brain waves of the users A, B, and C, which are detected by the brain electrodes 12A, 12B, and 12C, respectively, from the brain cells and which are obtained by the brain information obtaining unit 21, into experience codes having a common format among all of the users A, B, and C. In that case, a plurality of electrical signals of the brain waves of the users A, B, and C is associated to the thought information of the users. For example, using machine learning based on deep learning, the electrical signals of the brain waves are associated in advance to an experience code that represents the thought information of a user.

The encoder 23 converts the experience codes, which have a common format among all of the users A, B, and C, into electrical signals of the brain waves to be output to the brain cells of the users A, B, and C. In that case, the experience codes having the common format among all of the users A, B, and C are associated in advance to a plurality of electrical signals of the brain waves of the users A, B, and C using machine learning based on deep learning.

The filtering unit 24 selects only specific information from the brain information (the experience codes) of the users A, B, and C as obtained from the brain information obtaining unit 21, and outputs the selected specific information. For example, the filtering unit 24 selects only specific information based on the similarity between the brain information of the user A (a first-type subject) on the side of obtaining the brain information and the brain information of the users B and C (second-type subjects) on the side of the specific information. Then, based on the similarity between the brain information of the user A (the first-type subject) on the side of obtaining the brain information and the brain information of the users B and C (the second-type subjects) on the side of the specific information, the filtering unit 24 selects the users B and C, who output the specific information, from among a plurality of users B and C.

More particularly, the decoder 22 converts the electrical signals of the brain waves of the users A, B, and C into first-type experience codes having a common format among all of the users A, B, and C; and the filtering unit 24 processes the experience codes obtained by conversion by the decoder 22, and generates a second-type experience code by selecting only specific information. The encoder 23 converts the second-type experience code, which is generated by the filtering unit 24 and which includes the specific information, into electrical signals of the brain waves of the users A, B, and C; and outputs the electricals signals to the brain electrodes 12A, 12B, and 12C.

Regarding a specific configuration of the filtering unit 24, the explanation is given later.

The memory unit 25 stores therein a computer program that the control unit 13 executes to perform operation control. The memory unit 25 is an external storage device such as a hard disk drive (HDD), or is a memory. Moreover, the memory unit 16 stores therein threshold values that the control unit 13 uses in various determination operations.

### Filtering Unit

FIG. 2 is a block configuration diagram illustrating the filtering unit.

As illustrated in FIGS. 1 and 2, for example, the filtering unit 24 processes the first-type experience code, which represents the brain information of the user A on the side of obtaining the brain information, and generates a second-type experience code; and outputs the second-type experience code to the users B and C on the side of outputting specific information.

The filtering unit 24 includes a tag decoder 31, a tag filter 32, and a tag encoder 33.

The tag decoder 31 converts a first-type experience code into tag data representing a partially readable format. That tag filter 32 processes the tag data that is output by the tag decoder 31. The tag encoder 33 converts the tag data, which is output by the tag filter 32, into a second-type experience code.

The tag filter 32 is made of: a change flag representing the data that specifies those parts in the first-type experience code which should be changed; change information indicating the details that should be changed; and a changing unit that overwrites the parts, which are specified by the change flag, with the change information. For example, a first-type experience code is made of a plurality of sets of information S1, S2, S3, S4, and S5. Then, from among the sets of information S1, S2, S3, S4, and S5, the tag filter 32 assigns tags to specific sets of information S1, S2, S3 excluding the sets of information S4 and S5, and outputs the tagged sets of information S1, S2, and S3. Hence, the second-type experience code includes the specific sets of information S1, S2, and S3.

In that case, for example, from among the experience code of the user A and the experience codes of the user B and C, the tag filter 32 selects only the sets of information S1, S2, and S3 that have high relevance. Thus, from among the experience code of the user A and the experience codes of the user B and C, the tag filter 32 selects the users B and C having high relevance.

Meanwhile, at the time of performing machine learning, the decoder 22 of the control unit 13 performs machine learning in such a way that the brain waves released when the first-type user A is experiencing a plurality of data contents are converted into a first-type experience code representing the output of an experience encoder that has performed machine learning to convert the test contents into restorable and smaller units of data.

On the other hand, at the time of performing machine learning, the encoder 23 of the control unit 13 performs machine learning in such a way that the brain waves released when the users B and C are experiencing the test contents are converted from the first-type experience code into a second-type experience code.

The test contents represent contents such as video contents and instruction contents that allow the users A, B, and C to have predetermined experiences.

Meanwhile, the tag data can also contain a flag indicating that a specific person makes an appearance in the test contents, such as a “grandmother flag” indicating that a “grandmother” makes an appearance. When the first-type user A sees a “grandmother”, the “grandmother cells” present in the brain of the first-type user A fire; and, when the first-type experience code output by the decoder 22 is decoded using the tag decoder, the “grandmother flag” is set. Moreover, when the filtering unit 24 makes a change to clear the “grandmother flag” and then outputs the tag data to the encoder 23, the second-type users B and C do not recognize the “grandmother”.

The tag filter 32 can be configured to clear the information other than the specific information. For example, if the tag filter 32 is configured to clear the information that is not related to the playing of a musical instrument, when a person suffering from back pain is sharing the experience of playing a musical instrument, sharing information about the back pain can be avoided. Alternatively, if the tag filter 32 is configured to clear either the stimulation or the response, it becomes possible to retrieve either only the stimulation or only the response. Still alternatively, the tag filter 32 can be configured to highlight specific information. For example, when the tag filter 32 is configured to highlight the feeling of being moved, the second-type users become able to have more moving experiences.

Thus, from among the information extracted from the electrical signals of the brain of a user on one side and the information extracted from the electrical signals of the brain of a user on the other side, the specific information either implies the information that is common between the users or implies the information that is not common between the users. Moreover, the specific information can be set in advance.

### Information Processing Method

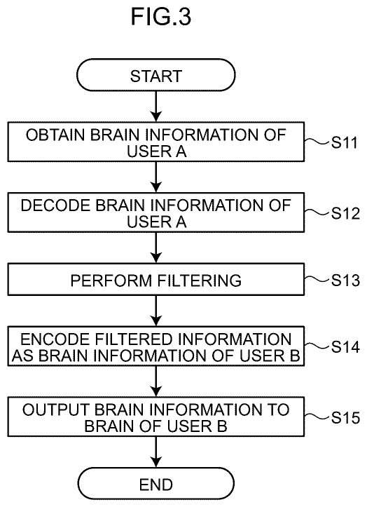

FIG. 3 is a flowchart for explaining an information processing method according to the present embodiment.

As illustrated in FIGS. 1 and 3, at Step S11, the brain information obtaining unit 21 obtains the electrical signals of the brain waves of the users A, B, and C as detected by the brain electrodes 12A, 12B, and 12C, respectively. At Step S12, the decoder 22 converts the electrical signals of the brain waves of the users A, B, and C, which are obtained by the brain information obtaining unit 21, into experience codes having a common format among all of the users A, B, and C.

At Step S13, for example, the filtering unit 24 processes the first-type experience code of the user A as obtained by conversion by the decoder 22, and generates a second-type experience code in which only specific information is selected. That is, in the filtering unit 24, the tag decoder 31 converts the first-type experience code into tag data representing a partially readable format; the tag filter 32 processes the tag data output by the tag decoder 31; and the tag encoder 33 converts the tag data, which is output by the tag filter 32, into a second-type experience code. More particularly, from among the sets of information S1, S2, S3, S4, and S5, the tag filter 32 excludes the sets of information S4 and S5 and generates a second-type experience code including only the specific sets of information S1, S2, S3.

At Step S14, the encoder 23 converts the second-type experience code, which is generated by the filtering unit 24 and which includes the specific information, into electrical signals of the brain waves of the users A, B, and C. Then, at Step S15, the encoder 23 outputs the electrical signals to the brain electrodes 12A, 12B, and 12C corresponding to the users A, B, and C, respectively.

In this case, from the first-type experience codes of the users A, B, and C, the filtering unit 24 removes the noncommon information and allows passage of the second-type experience code including only the common information. Alternatively, the filtering unit 24 can remove the common information, and the second-type experience code including only the noncommon information can be allowed to pass. For example, assume that it starts raining during a baseball-related conversion between the first-type user A and the second-type users B and C. At that time, an experience code related to baseball, an experience code related to rain, an experience coder related to breathing, and an experience code related to the heart rate are output as the first-type experience codes from the first-type user A and the second-type user B. On the other hand, from the third-type user C who is not talking about baseball, an experience code related to rain, an experience code relate to breathing, and an experience code related to the heart rate are output. In that case, the experience code related to rain, the experience code relate to breathing, and the experience code related to the heart rate are output as the first-type experience codes; and the experience code related to baseball is not included in the first-type experience codes. Hence, among the users A, B, and C, either the information related to rain, the information related to breathing, and the information related to the heart rate can be shared, or the information related to baseball can be shared.

More particularly, the users A, B, and C are wearing the brain electrodes 12A, 12B, and 12C, respectively. The control unit 13 is configured as a server, and the brain information obtaining unit 21 thereof obtains the electrical signals of the brain waves of the users A, B, and C from the brain electrodes 12A, 12B, and 12C, respectively. Then, the brain information obtaining unit 21 sends the electrical signals of the brain waves of the users A, B, and C to the filtering unit 24; and the filtering unit 24 decides on the electromagnetic waves, which are to be output, based on the information about the brain waves of the user A. That is, based on the first-type experience codes of the users A, B, and C, the filtering unit 24 generates a task command (a second-type experience code) to be output to the users B and C.

Subsequently, the filtering unit 24 decides on the user, from among the users A, B, and C, to whom the task command is to be sent. The filtering unit 24 has already obtained the brain waves of the other users B and C, and selects the user whose brain waves are most similar to the brain waves of the task command (the first-type experience code or the second-type experience code). Then, the filtering unit 24 sends the task command (the second-type experience code) to the selected user.

The degree of similarity of the brain waves can be obtained by evaluating the brain waves and treating the brain waves having the smallest classification error as similar brain waves. For example, the task command (the second-type experience code) is sent to the user B who is closest to the user A in terms of the four quadrants including the degree of activity (active/inactive) of the brain and the degree of comfort/discomfort.

More particularly, the degree of activity (the degree of inactivity) and the degree of comfort (the degree of discomfort) representing the brain state of the user can be determined using a variety of technologies. For example, from among the electrical signals of the brain waves of the users as obtained by the brain information obtaining unit 21, the filtering unit 24 can measure the response of the θ bandwidth in the region of interest in the brain (i.e., can measure the electrical signals of an EEG) and calculate the degree of comfort (the degree of discomfort). Alternatively, from among the electrical signals of the brain waves of the user as obtained by the brain information obtaining unit 21, the filtering unit 24 can measure the response of the β bandwidth of the region of interest in the brain (i.e., can measure the electrical signals of an EEG) and calculate the degree of activity (the degree of inactivity). Alternatively, regarding calculating the degree of similarity between the brain waves, according to the result of calculating the degree of activity and the degree of comfort/discomfort of the brain of the user on one side, it can be determined whether or not the user on the other side has an identical degree of activity and an identical degree of comfort/discomfort of the brain. For example, when the brain of the user A is active and in comfort, the task command (the second-type experience code) is sent to the user B for whom an identical calculation result (indicating that the brain is active and in comfort) is obtained. Alternatively, with respect to the degree of activity and the degree of comfort/discomfort of the brain of the user on one side, the task command (the second-type experience code) is sent to that user on the other side who has the closest values. As a result of implementing such a method, the task command (the second-type experience code) is sent to the user B who has the closest emotions to the user A, and the neural network of the brain can be shared under an empathic environment.

Meanwhile, instead of selecting the user having the most similar brain waves as the destination, the filtering unit 24 can select the user having the least similar brain waves as the destination. According to that method, the neural network of the brain can be shared under diverse environments. Alternatively, the filtering unit 24 can classify the content of the task command (the second-type experience code) and accordingly decide the destination. When the task command for the user A indicates “I wish to talk about baseball”, the users who are thinking about the keyword “baseball” can be treated as the selection targets. For example, since the brain waves can be obtained from the brain electrodes 12A, 12B, and 12C and the contents that the users are attempting to speak can be estimated from the brain waves, the brain waves can be converted into a language and the keyword “baseball” can be picked up. According to that method, it becomes possible to carry out the search.

Alternatively, the content of a task can be classified from the task command based on the brain waves, and the task command can be sent to the user who outputs the brain waves suitable for that task. For example, assume that the user A outputs a task command indicating “take minutes”. Moreover, assume that the task command is classified to belong to “description of text”. Thus, the task command is sent to that user who outputs the brain waves suitable for “description of text” (for example, the user whose brain state is inactive to some extent). Alternatively, assume that the user A outputs a task command indicating “I wish to have a debate”. Moreover, assume that the task command is classified to belong to “conversation”. Thus, the task command is sent to that user who outputs the brain waves suitable for “conversation” (for example, the user whose brain state is active to some extent).

Meanwhile, the elements of the tag data are treated as the reaction weight with respect to the standard stimulations (an image of a dog, an image of a cat, a sweet smell, a sour smell, and the sense of touch in the hand) representing the stimulations provided in advance. At the time of creating a tag decoder, learning can be performed in such a way that the probability of each standard stimulation is estimated from the experience code at the time when that standard stimulation is applied to a particular user; and, at the time of creating a tag encoder, learning can be performed in such a way that the experience code is estimated from the probability of each standard stimulation.

### Effects of Embodiment

The information processing device according to the present embodiment includes: the brain information obtaining unit 21 that obtains the brain information of a user (a subject); the filtering unit 24 that selects only specific information from the brain information generated by the brain information obtaining unit 21; and the encoder (an output unit) 23 that outputs the specific information, which is selected by the filtering unit 24, to the subject.

Thus, the filtering unit 24 outputs only the specific information, which is selected from the brain information of a first-type user, to a second-type user. As a result, it becomes possible to share only the required information among a plurality of subjects.

In the information processing device according to the present embodiment, the filtering unit 24 selects only the specific information based on the degree of similarity between the brain information of a first-type user (a first-type subject), who is the target for obtaining the brain information, and the brain information of a second-type user (a second-type subject) who is the target for outputting the specific information. For that reason, the specific information can be selected with ease based on the degree of similarity between the first-type user and the second-type user.

In the information processing device according to the present embodiment, the filtering unit 24 selects, from among a plurality of second-type users, the second-type users to whom the specific information is to be output based on the brain information of a first-type user (a first-type subject), who is the target for obtaining the brain information, and the brain information of the second-type users (the second-type subjects) who are the targets for outputting the specific information. For that reason, based on the degree of similarity between the first-type user and the second-type users, the users to whom the specific information is to be sent can be selected with ease.

Till now, the explanation was given about the information processing device according to the application concerned. However, the application concerned can be implemented according to various other forms other than the embodiment described above.

The constituent elements of the information processing device illustrated in the drawings are merely conceptual, and need not be physically configured as illustrated. The constituent elements, as a whole or in part, can be separated or integrated either functionally or physically based on various types of loads or use conditions.

The information processing device is configured using, for example, a computer program that is loaded as software in a memory. In the embodiment described above, the configuration is explained with reference to function blocks implemented as a result of coordination between hardware and software. Such function blocks can be implemented in various ways, such as using only hardware, or using only software, or using a combination of hardware and software.

According to the application concerned, it becomes possible to share only the required information among a plurality of subjects.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing device comprising:
a brain information obtaining unit that obtains brain information of a subject;
a filtering unit that selects only specific information from the brain information obtained by the brain information obtaining unit; and
an output unit that outputs the specific information, which is selected by the filtering unit, to a subject.

2. The information processing device according to claim 1, wherein the filtering unit selects only the specific information based on degree of similarity between brain information of a first-type subject, who is target for obtaining brain information, and brain information of a second-type subject, who is target for outputting the specific information.

3. The information processing device according to claim 1, wherein, based on degree of similarity between brain information of a first-type subject, who is target for obtaining brain information, and brain information of a plurality of second-type subjects representing targets for outputting the specific information, the filtering unit selects a second-type subject to whom the specific information is to be output from among a plurality of second-type subjects.

4. An information processing method comprising:
obtaining brain information of a subject;
selecting only specific information from the obtained brain information; and
outputting the selected specific information to a subject.

5. A computer program product having a computer readable medium including a computer program, wherein the computer program, when executed by a computer, causes the computer to execute:
obtaining brain information of a subject;
selecting only specific information from the obtained brain information; and
outputting the selected specific information to a subject.
